(19) United States
(12) Patent Application Publication
(10) Pub. No.: US 2024/0145667 A1
(43) Pub. Date: May 2, 2024

(54) Method and Apparatus for Producing an Electrode

(71) Applicant: Bayerische Motoren Werke Aktiengesellschaft, Muenchen (DE)

(72) Inventor: Dongho JEONG, Neubiberg (DE)

(21) Appl. No.: 18/280,795

(22) PCT Filed: Feb. 23, 2022
(86) PCT No.: PCT/EP2022/054495

§ 371 Date: Sep. 7, 2023

(30) Foreign Application Priority Data
Mar. 8, 2021 (DE) 10 2021 105 458.3

(51) Int. Cl. H01M 4/04; H01M 10/0525

(52) U.S. Cl. CPC H01M 4/0471; H01M 4/0404; H01M 10/0525

(57) ABSTRACT

A method is provided for producing an electrode for a battery cell, wherein the electrode at least partly has a coating. The method includes performing first mechanical compacting of the electrode to form a first compacted state of the electrode by using a first compacting arrangement for compacting the coating, and supplying at least one coated portion of the electrode with thermal energy by using at least one device with a thermal-energy source, to reduce mechanical stresses in the electrode. The step of supplying with thermal energy being performed before and/or after the first mechanical compaction.

### BACKGROUND AND SUMMARY OF THE INVENTION

The present invention relates to a method and an apparatus for producing an electrode for a battery cell, in particular for a lithium ion cell.

Electrodes, in particular electrodes having mechanically compacted active material, are used, for example, in battery cells for electric vehicles.

What is called calendering is a known method in the production of electrodes. In this method, the electrodes, which have an electrically conductive carrier substrate, usually composed of metal, and an active material applied thereto which is of electrochemical relevance with regard to the use of the electrode in a galvanic element, are subjected to high mechanical stress during their production in order to attain a high bulk density, in particular in the active material. The electrodes are conducted here between two rollers that exert a mechanical pressure on the electrode, such that it undergoes compaction as it is conducted through and hence the bulk density of the electrode is increased. A higher bulk density of electrodes regularly enables a higher energy density of a battery cell in which these electrodes are used.

On account of the high mechanical pressure on the electrode in the compacting operation, mechanical stresses often build up within the electrode. After compression of the electrode, a rebound effect may occur, in the case of which the stresses within the electrode are released and the compaction of the electrode is reversed again. This may result in the last compression by the rollers being completely reversed and the electrode having the previous thickness again.

The invention is based on the object of providing an improved method for producing an electrode with a high energy density.

This object is achieved according to the teaching of the claimed invention.

A first aspect of the invention relates to a method for producing an electrode for a battery cell, wherein the electrode has a coating at least in sections, having the following steps: a first mechanical compaction of the electrode to form a first compacted state of the electrode using a first compaction arrangement for compacting the coating; and supplying the electrode with thermal energy in at least one coated section using at least one device having a thermal energy source for reducing mechanical stresses in the electrode, wherein thermal energy is supplied before and/or after the first mechanical compaction.

The first mechanical compaction of the electrode produces mechanical stresses within the electrode. These stresses, or else residual stresses, in the electrode build up mainly in the binder structure thereof. Uncontrolled release of these mechanical stresses can lead to what is called a rebound effect, in the case of which the electrode expands and, as a result, has a greater thickness than immediately after the first mechanical compaction. Therefore, it is necessary to dissipate the stresses in a controlled manner or not to allow them to arise at all. The stresses can be dissipated more quickly at high temperatures than at lower temperatures. High temperatures in this context are preferably temperatures in a temperature range of 100° C.-160° C., preferably of 120° C.-150° C. It is therefore advantageous to supply thermal energy to the electrode before and/or after the first mechanical compression. Supplying thermal energy before the first compression has the advantage that fewer stresses build up within the electrode during the first mechanical compaction. Supplying thermal energy after the first compression has the advantage that stresses build up within the electrode during the first mechanical compaction, but the electrode does not expand or expands to a lesser extent compared with the expansion without the supply of thermal energy.

There follows a description of preferred embodiments of the method, each of which, unless explicitly excluded or technically impossible, may be combined as desired with one another and with the other aspects of the invention described, or used as corresponding embodiments of the latter.

According to some embodiments, one or more regions of the electrode are selectively supplied with thermal energy, which regions have a lower coating thickness at the time at which thermal energy is supplied than the maximum coating thickness at this time.

According to some embodiments, an uncoated section of the electrode is additionally supplied with thermal energy.

On account of the high mechanical pressure on the respective electrode and the resulting stresses within the electrode, expansion differences between coated and uncoated regions occur. These expansion differences cause deformation of the electrode. These expansion differences may be reduced by supplying thermal energy to the regions with a reduced coating thickness and/or to the uncoated regions.

A second aspect of the invention relates to an apparatus for producing an electrode, wherein the apparatus is configured to carry out the method according to the first aspect.

There follows a description of preferred embodiments of the apparatus, each of which, unless explicitly excluded or technically impossible, may be combined as desired with one another and with the other aspects of the invention described, or used as corresponding embodiments of the latter.

According to some embodiments, the electrode has a coating at least in sections, wherein the apparatus has a first compaction arrangement for a first mechanical compaction of the electrode, and a device having a thermal energy source for supplying the electrode with thermal energy, wherein the device is arranged upstream or downstream of the first compaction arrangement. The device is therefore arranged in such a manner that the electrode can be supplied with thermal energy before or after the first mechanical compaction. It is likewise conceivable for the apparatus to have a further device having a thermal energy source which is arranged in such a manner that the electrode can be supplied with thermal energy before and after the first mechanical compaction.

Supplying thermal energy before the first compression has the advantage that fewer stresses build up within the electrode during the first mechanical compaction. Supplying thermal energy after the first compression has the advantage that stresses build up within the electrode during the first mechanical compaction, but the electrode does not expand or expands to a lesser extent compared with the expansion without the supply of thermal energy.

According to some embodiments, the thermal energy source has a limiting element which is designed to supply a predetermined region of the electrode with thermal energy. This means that thermal energy is supplied only to the predetermined region, for example only an uncoated region of the electrode, rather than to the entire electrode.

According to some embodiments, the thermal energy source has an infrared lamp heater or an induction device. When using an infrared lamp heater, the limiting element may have, for example, a mechanical screen which is fitted between the infrared lamp heater and the region to which thermal energy or heat is intended to be supplied. An infrared lamp heater heats the ambient air, thus resulting in a heated air flow which is supplied to the desired region of the electrode. An infrared lamp heater has the advantage that it is independent of the material of the electrode and can be used in a stand-alone manner, that is to say without direct contact with the electrode.

When using an induction device, the thermal energy is supplied to the electrode via electromagnetic interaction between the electrode and the thermal energy source. In this case, the same principle as in an induction cooker is used. Supplying thermal energy by way of induction has the advantage that a high degree of efficiency is achieved in this case.

According to some embodiments, the device has at least one guide roll which can be used to convey the electrode during operation of the apparatus. In this case, the electrode can move above or below the guide roll, on the basis of its direction of movement. The guide roll is preferably arranged upstream or downstream of the compaction arrangement and supplies the electrode to the first compaction arrangement or accepts the electrode from the compaction arrangement for further conveying.

According to some embodiments, the at least one guide roll is in the form of an unwinding roll, on which the electrode is initially rolled up and is continuously unrolled during supply to the first compaction arrangement. However, it is also conceivable for the guide roll to be in the form of a winding roll, on which the electrode is rolled up again after the compaction. The apparatus may likewise have a winding roll and an unwinding roll.

According to some embodiments, the at least one guide roll is thermally coupled to a thermal heat source, as a result of which the at least one guide roll can be supplied with thermal energy. As a result, the guide roll supplies the electrode with thermal energy when conveying the electrode. Thermal energy is supplied via mechanical contact and is therefore also more effective than using the air, for example.

According to some embodiments, the at least one guide roll has at least one thermal insulation element. The at least one thermal insulation element preferably has depressions in the guide roll, which thermally insulate the guide roll from the electrode during conveying. In this case, thermal energy has already been supplied to the electrode before conveying by the guide roll, and the intention is to prevent the electrode from transmitting thermal energy to the guide roll as a result of mechanical contact with the guide roll.

According to some embodiments, the device has a plurality of guide rolls, wherein at least two of the plurality of guide rolls are arranged on different levels with respect to the direction of movement of the electrode. This extends the distance and the period of time needed to convey the electrode from the first compaction arrangement to a second compaction arrangement. The period of time in which the electrode is supplied with thermal energy in order to reduce mechanical stresses is accordingly extended.

According to some embodiments, the plurality of guide rolls are arranged in a meandering manner within the device. This achieves the longest possible distance covered by the electrode within the device.

According to some embodiments, the apparatus has a second compaction arrangement for a second mechanical compaction of the electrode to form a second compacted state of the electrode, wherein the electrode has a higher compaction in the second compacted state than in the first compacted state, and wherein the device having the thermal energy source is arranged downstream of the first compaction arrangement and upstream of the second compaction arrangement.

In this case, the device having the thermal energy source is arranged in such a manner that the electrode can be supplied with thermal energy after the first mechanical compaction and before the second mechanical compaction.

It is also conceivable for a further device to be arranged in such a manner that thermal energy is supplied to the electrode again after the second mechanical compaction in order to dissipate the mechanical stresses which are caused by the second mechanical compaction.

A second mechanical compaction has the advantage of compensating for a possible rebound effect. In addition, a lower thickness and therefore a higher energy density of the electrode can be achieved with a second mechanical compaction. The supply of thermal energy before and/or after the first mechanical compaction has the advantage that the rebound effect after the second mechanical compaction is avoided or at least considerably reduced.

According to some embodiments, the first compaction arrangement and/or the second compaction arrangement has/have a roller arrangement. In this case, a roller arrangement has two rollers, in particular two rollers with a cylindrical shape, the main axes of which run in a substantially parallel manner. In this case, the two rollers are at a distance from one another, wherein the electrode is conveyed through this distance. The distance corresponds substantially to the thickness to which the electrode is intended to be compacted or compressed.

A third aspect of the invention relates to an electrode that can be obtained in accordance with a method according to the first aspect of the invention.

A fourth aspect of the invention relates to a battery cell having an electrode according to the third aspect.

Further advantages, features and possible uses of the present invention will be apparent from the detailed description that follows, in association with the figures.

### BRIEF DESCRIPTION OF THE DRAWINGS

FIG. 1a and FIG. 1b schematically show an arrangement having a relaxation module for processing an electrode.

FIG. 2 schematically shows configurations of the relaxation module.

FIG. 3 schematically shows an electrode having regions of different coated thickness.

FIG. 4 schematically shows an arrangement having a second compaction unit.

FIG. 5 schematically shows a change in electrode thickness on the basis of processing by the arrangement.

FIGS. 6a-6d schematically show method steps for heat treatment by way of a guide roll if there is an uneven coating.

FIG. 7 schematically shows a guide roll with depressions and an electrode.

FIGS. 8a-8d schematically shows different geometries of depressions in the guide roll.

### DETAILED DESCRIPTION OF THE DRAWINGS

Throughout the figures, the same reference signs are used for the same or mutually corresponding elements of the invention.

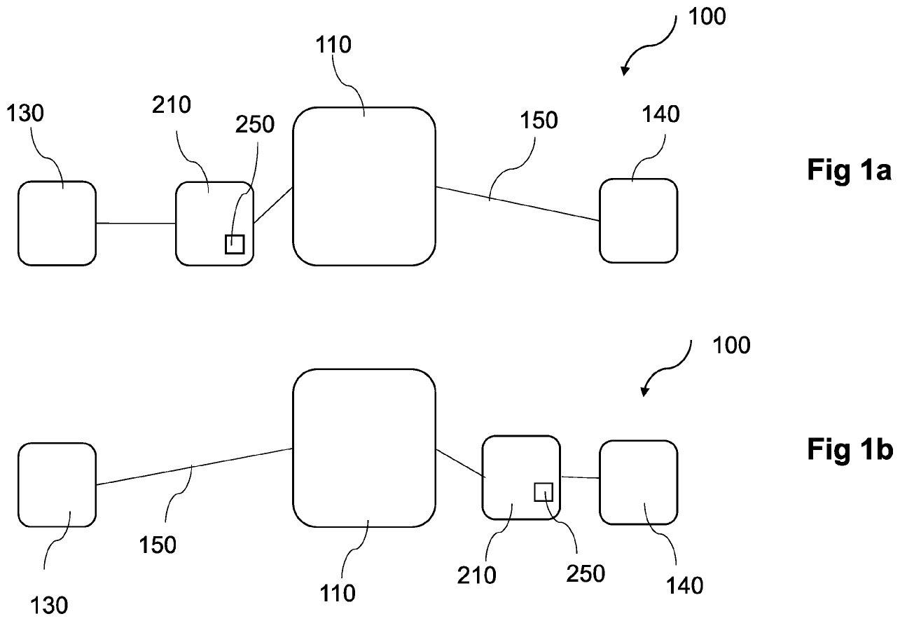

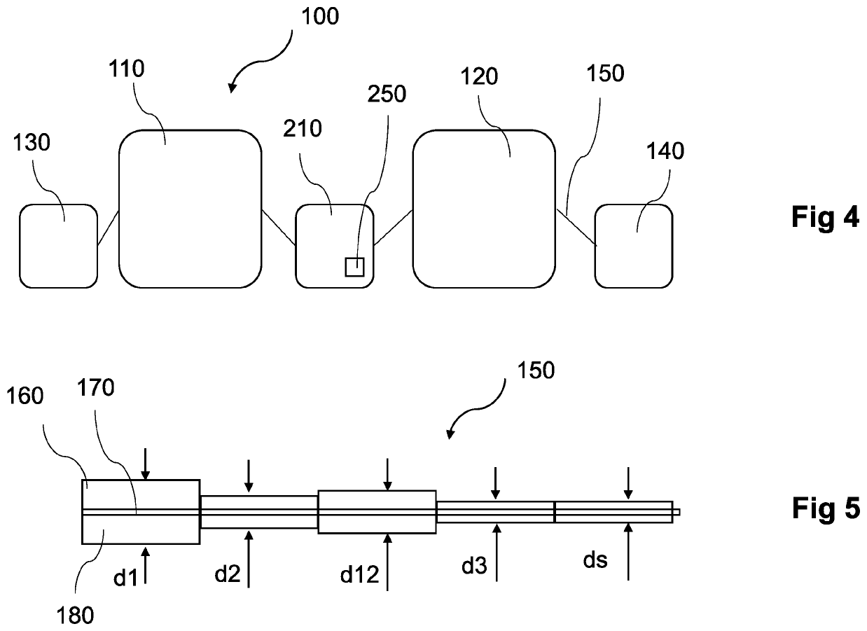

FIGS. 1a and 1b schematically show a compaction apparatus 100 for processing an electrode 150. The compaction apparatus 100 has an unwinding roll 130, a relaxation module 210, a first compaction unit 110 and a winding roll 140. The first compaction unit 110 and also the second compaction unit 120 (see FIG. 4) each have a roller pair (not shown here), where the main axes of the rollers, which have a cylindrical shape, run substantially parallel to one another. The roller pairs are each arranged at a distance from one another which is lower than the thickness of the electrode supplied, and correspond to the thickness that the electrode is intended to have as a result of the compaction by the respective roller pair.

The electrode 150 is arranged on an unwinding roll 130, from which the electrode 150 is correspondingly unwound and supplied to the relaxation module 210. In the relaxation module 210, the electrode is supplied with thermal energy by a thermal energy source 250 arranged therein. This thermal energy is supposed to prevent mechanical stresses from building up as a result of the compaction in the compaction unit 110. Subsequently, the electrode 150 is supplied to the first compaction unit 110, in which it is compressed. Downstream of the first compaction unit 110, the electrode 150 is rolled up on a winding roll 140.

According to FIG. 1b, the relaxation module 210, in contrast to FIG. 1a, is not arranged upstream of the first compaction unit 110 but downstream of the compaction unit 110 and upstream of the winding roll 140. This achieves the effect that compactions that have built up in the electrode 150 by virtue of the compaction in the compaction unit 110 are dissipated again. The arrangement of the further components is identical to that shown in FIG. 1a.

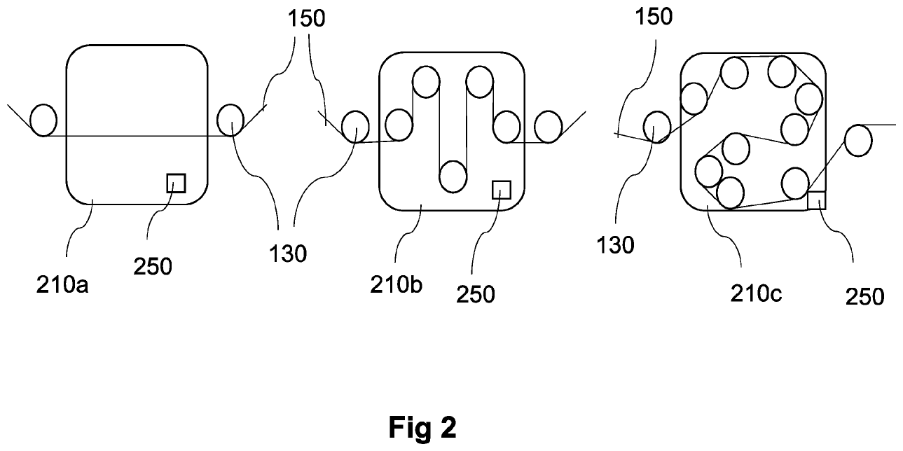

FIG. 2 schematically shows three possible configurations of the relaxation module 210, which are called relaxation module one 210a, relaxation module two 210b, and relaxation module three 210c. The relaxation modules 210a, 210b, 210c described each have two or more guide rolls 130 which convey the electrode 150. The guide rolls 130 may also be configured as deflecting rolls, such that the electrode 150 is deflected at a particular angle from its original direction of movement while it is being conveyed. Conveying the electrode 150 over the additional distance extends the period of time needed by the electrode 150 to cover the distance within the relaxation module. In this period of time, the electrode 150 is supplied with thermal energy by the thermal energy source 250. In this respect, the extending of the distance extends the period of time in which the electrode 150 is supplied with thermal energy. As described above, depending on the positional arrangement, buildup of stress within the electrode 150 is prevented thereby, or stress already present is dissipated again. The thermal energy source 250 is, for example, an infrared lamp heater or an induction device. The thermal energy is at a temperature between 100° C. and 160° C. An advantageous temperature has been found to be between 120° C. and 150° C., in particular 150° C. The temperature may be optimized in accordance with the material composition of the electrode 150 and the thermal energy source used.

In relaxation module one 210a, the electrode 150 is conveyed by way of two guide rolls 130 that are spaced apart from one another. The guide rolls 130 are each arranged offset from the direction of movement, such that the electrode 150 undergoes deflection from its original direction. As a result, firstly, the distance covered by the electrode 150 is extended. Secondly, the deflection angle of the two guide rolls 130 can be used to control the angles at which the electrode 150 is supplied to relaxation module one 210a, and the angle at which the electrode 150 is removed from relaxation module one 210a and supplied, for example, to a compaction unit 110, 120.

In relaxation module two 210b, the electrode 150 is conveyed by way of seven guide rolls 130 that are each spaced apart from one another. The electrode 150 in relaxation module two 210b is deflected on the inlet side by a guide roll 130 at an angle of essentially 90 degrees. Thereafter, the electrode 150 is deflected by three successive guide rolls, in each case by 180 degrees. This is followed by a further guide roll 130 that deflects the electrode 150 again by 90 degrees, such that the electrode 150 reattains its original direction. It is also conceivable that the distance covered is additionally extended by further 180 degree deflections. Depending on whether the electrode 150, in its reattained original direction, is intended to be conveyed above or below the subsequent guide rolls 130, the number of 180 degree deflections may be adjusted.

In relaxation module three 210c, the electrode 150 is conveyed by way of 11 guide rolls 130 that are each spaced apart from one another. The guide rolls 130 are arranged on a curved track, which changes its direction several times.

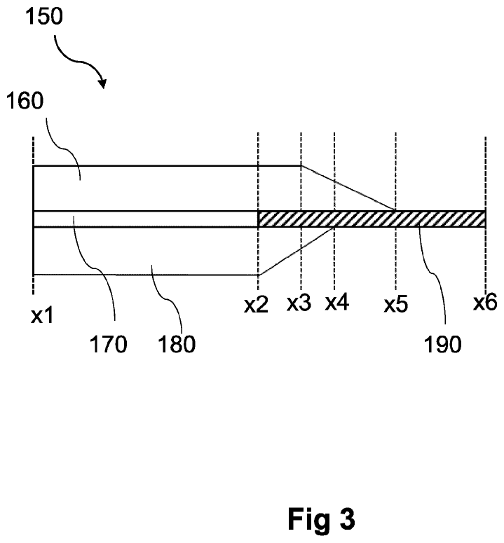

FIG. 3 schematically shows an electrode having regions of different coated thickness. The electrode 150 has an electrode foil 170 arranged between a first electrode coating 160 and a second electrode coating 180. The electrode coatings 160, 180 are electrically conductive. In addition, the electrode is divided into five regions that are respectively arranged between the region boundaries x1-x6 shown. Accordingly, region 1 is arranged between region boundaries x1 and x2, region 2 is arranged between region boundaries x2 and x3, region 3 is arranged between region boundaries x3 and x4, region 4 is arranged between region boundaries x4 and x5, and region 5 is arranged between region boundaries x5 and x6.

In region 1, the first electrode coating 160 and the second electrode coating 180 have the same constant thickness over the entire region.

In region 2, the first electrode coating 160 has a constant thickness over the entire region, which is identical to the thickness of the coating of region 1. The second electrode coating 180 has a decreasing thickness in the direction away from region 1.

In region 3, the first electrode coating 160 has a decreasing thickness in directions away from region 2, as does the second electrode coating 180. The thicknesses and also the decrease in the thicknesses of the first electrode coating 160 and of the second electrode coating 180 are different. The thickness of the second electrode coating 180 decreases to zero, such that the foil is uncoated on one side at the boundary with region 4.

In region 4, one side of the foil is uncoated, while the second electrode coating 180 on the other side decreases across the region to a value which is at least close to zero and which is at the boundary with region 5.

In region 5, the foil 170 of the electrode 150 is completely uncoated.

In regions 2 to 5 of the electrode 150 in which the foil is coated with relatively low thickness at least on one side or is uncoated, unevenness can arise in the case of compression. This can hinder frictionless conveying of the electrode 150. It is therefore advantageous to supply thermal energy in particular to the regions mentioned, in order to avoid unevenness. The foil 170 is correspondingly supplied with thermal energy by the thermal energy source in a foil subregion 190 coated with lower thickness at least on one side.

FIG. 4 schematically shows a compaction apparatus 100 having a first compaction unit 110, a second compaction 120, and a relaxation module 210 which is arranged between the first compaction unit 110 and the second compaction unit 120 in relation to the conveying of the electrode 150, such that the electrode 150 passes through the relaxation module 210 downstream of the first compaction unit 110 and upstream of the second compaction unit 120. The relaxation module 210 has a thermal energy source 250. In addition, the compaction apparatus 100 has a guide roll 130 that supplies the electrode 150 to the first compaction unit 110. In the first compaction unit 110, the electrode is compressed to a first thickness. This gives rise to mechanical stresses in the electrode 150. These stresses are dissipated in the relaxation module 250 by the supply of thermal energy by the thermal energy source 250. Thereafter, the electrode 150 is supplied to the second compaction unit 120, in which the electrode 150 is compressed to a second thickness smaller than the first thickness. The prior supply of thermal energy prevents an uncontrolled dissipation of the mechanical stresses after the first compression and also after the second compression, and prevents the electrode 150 from expanding again.

FIG. 5 schematically shows a change in thickness of an electrode 150 on the basis of the processing by the compaction apparatus 100 according to FIG. 4. The electrode 150 has an electrode foil 170 arranged between a first electrode coating 160 and a second electrode coating 180. The first compaction unit 110 compresses the electrode 150 from the original thickness d1, with which the electrode 150 is supplied to the first compaction unit 110, to a first thickness d2. Thereafter, the electrode 150 passes through the relaxation module 210 in which the electrode 150 is supplied with thermal energy by the thermal energy source 250. This dissipates stresses within the electrode 150. However, the stresses are possibly not fully dissipated, and the rebound effect described causes the thickness of the electrode to increase from the first thickness d2 to an intermediate thickness d12, but one that is lower than the original thickness d1 of the electrode. The electrode 150 is fed with the intermediate thickness d12 to the second compaction unit 120, and compressed to the second thickness d3. The thickness of the electrode 150 then remains constant at the second thickness d3, which corresponds to the target thickness ds, because the stresses have been dissipated in the relaxation module 210.

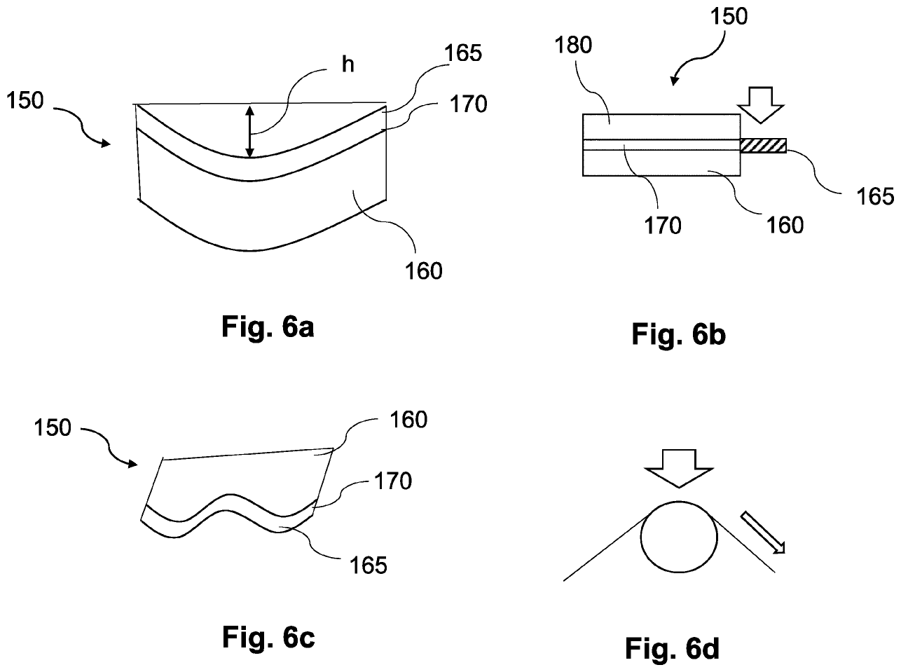

FIGS. 6a-d schematically show the method steps for heat treatment by way of a guide roll if there is an uneven coating.

FIG. 6a shows an electrode 150 having an electrode foil that has been coated only on one side with a first electrode coating 160, and an uncoated region 165. During a compaction, for example in the first compaction unit 110, only the coated region of the electrode 150 is compressed and correspondingly stretched along the longitudinal axis of the electrode 150. Mechanical stress on one side of the electrode 150 can result in deformation of the electrode 150. This can lead to bending of the electrode 150 toward the uncoated side of the electrode 150, which can lead to a difference in height h in the bent region.

FIG. 6b schematically shows an electrode 150, in which an uncoated region 165 is shown. The uncoated region 165 is supplied with thermal energy in order to attenuate the bending. The thermal energy may be supplied to the uncoated region 165 by induction, for example.

FIG. 6c shows an electrode 150 that has been supplied with additional thermal energy by way of induction. The region that has been supplied with the thermal energy has become deformed. This deformation results from the expansion of the heated region 165 on the one hand, and the effect of an electromagnetic force by the induction on the other hand.

FIG. 6d shows a guide roll 130 via which the electrode 150 is guided, while the electrode 150 is being supplied with thermal energy. So that the uncoated region 165 does not become deformed because of differences in heat, it is necessary to supply the uncoated region 165 uniformly with thermal energy, such that the uncoated region 165 has a constant temperature over its full area. For this purpose, it is necessary for the distance between the thermal energy source and the uncoated region 165 to remain constant during the supply of thermal energy. This requires the guide roll 130 to be at a constant distance from the electrode 150 while the thermal energy is being supplied. This can be achieved, for example, by virtue of the fact that there is no electromagnetic force interaction between the electrode 150 and the guide roll 130, which can arise in particular when the thermal energy is supplied to the electrode by way of induction and the guide roll includes a ferromagnetic material. When the guide roll comprises an electrically nonconductive material, for example a plastic, this electromagnetic force interaction may be avoided, and the distance between the guide roll 130 and the electrode 150 may be kept constant.

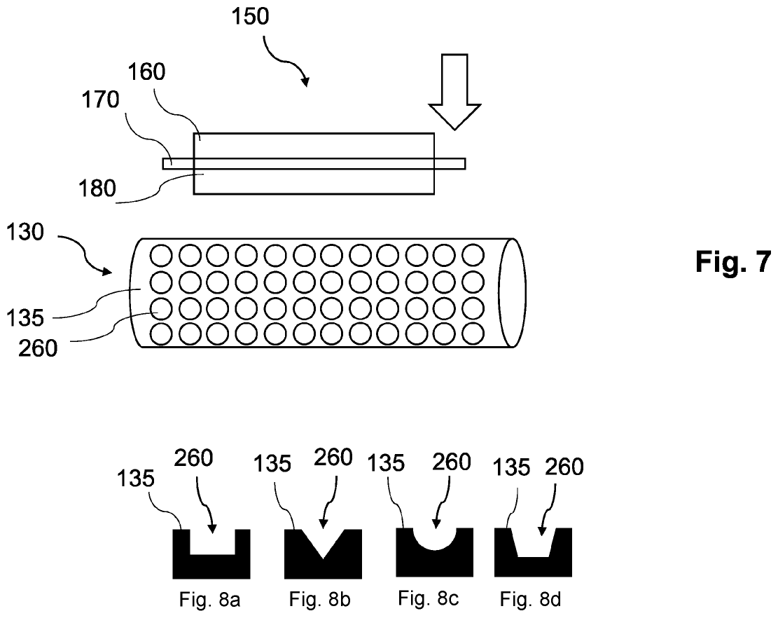

FIG. 7 schematically shows a guide roll 130 and an electrode 150. The guide roll also has a rolling face having a contact face 135 and depressions 260. The depressions 260 extend radially inward from the rolling face with regard to the axis of the guide roll. The electrode 150 has an electrode foil 170 arranged between a first electrode coating 160 and a second electrode coating 180. The electrode coatings 160, 180 are electrically conductive. It is advantageous if the electrode 150 has been supplied with thermal energy prior to the compression, and the electrode 150 is at a predetermined temperature during the compression. As a result, fewer mechanical stresses build up within the electrode 150 during the compression. When the electrode 150 is conveyed by the guide roll 130, the mechanical contact between the electrode 150 and the guide roll 130 can transfer thermal energy from the electrode 150 to the guide roll 130. The depressions 260 have a thermally insulating effect here, such that the transfer of heat to the guide roll 130 is at least reduced. The thermal energy can be supplied to the electrode 150 by way of electrical induction (not shown here). When the electrode 150 is supplied with thermal energy by way of electrical induction during unrolling on the roll and the guide roll 130, or its surface, is electrically conductive, a force acts from the electrode 150 on the roll. In order to prevent this, it is advantageous if the guide roll is made from an electrically nonconductive material. The electrically nonconductive or insulating material may comprise a plastic or ceramic, for example.

FIGS. 8a-8d schematically show different geometries of depressions 260 in the guide roll 130, which extend inward from the rolling face. FIG. 8a shows a depression 260 with a rectangular cross section. The depression 260 may have the form of a groove, a cylinder or else a cuboid. FIG. 8b shows a depression 260 with a triangular cross section. The depression 260 may have the form of a groove or a cone. FIG. 8c shows a depression 260 with a semicircular cross section. The depression 260 may have the form of a groove or a hemisphere. FIG. 8d shows a depression with a trapezoidal cross section. The depression may have the form of a groove or a pyramid, in particular a truncated pyramid.

The invention is suitable for producing electrodes for battery cells, in particular for battery cells for motor vehicle batteries.

### LIST OF REFERENCE SIGNS

100 Compaction apparatus
110 First compaction unit
120 Second compaction unit
130 Guide roll
135 Contact face
140 Winding roll
150 Electrode
160 First electrode coating
165 Uncoated region
170 Electrode foil
180 Second electrode coating
190 Foil subregion
d1, d2, d12, d3, ds Thicknesses of the electrode
x1, x2, x3, x4, x5, x6 Region boundaries
210 Relaxation module
210a Relaxation module one
210b Relaxation module two
210c Relaxation module three
250 Thermal energy source
260 Depressions

1.-15. (canceled)

16. A method for producing an electrode for a battery cell, wherein the electrode has a coating at least in sections, the method comprising:
performing a first mechanical compaction of the electrode to form a first compacted state of the electrode using a first compaction arrangement for compacting the coating; and
supplying the electrode with thermal energy in at least one coated section using at least one device having a thermal energy source for reducing mechanical stresses in the electrode, wherein the thermal energy is supplied at least one of before or after the first mechanical compaction.

17. The method according to claim 16, wherein one or more regions of the electrode are selectively supplied with the thermal energy, which one or more regions have a lower coating thickness at a time at which the thermal energy is supplied than a maximum coating thickness at the time at which the thermal energy is supplied.

18. The method according to claim 16, wherein an uncoated section of the electrode is additionally supplied with thermal energy.

19. An apparatus for producing an electrode which has a coating at least in sections, the apparatus comprising:
a first compaction arrangement for a first mechanical compaction of the electrode; and
a device having a thermal energy source for supplying the electrode with thermal energy, wherein the device is arranged upstream or downstream of the first compaction arrangement.

20. The apparatus according to claim 19, wherein the thermal energy source has a limiting element which is configured to supply a predetermined region of the electrode with thermal energy.

21. The apparatus according to claim 19, wherein the thermal energy source has an infrared lamp heater or an induction device.

22. The apparatus according to claim 19, wherein the device has at least one guide roll which is configured to convey the electrode during operation of the apparatus.

23. The apparatus according to claim 22, wherein the at least one guide roll is thermally coupled to a thermal heat source, as a result of which the at least one guide roll is suppliable with the thermal energy.

24. The apparatus according to claim 23, wherein the at least one guide roll has at least one thermal insulation element.

25. The apparatus according to claim 20, wherein the device has a plurality of guide rolls, and at least two guide rolls of the plurality of guide rolls are arranged on different planes with respect to a direction of movement of the electrode.

26. The apparatus according to claim 25, wherein the plurality of guide rolls are arranged in a meandering manner within the device.

27. The apparatus according to claim 19, further comprising:
a second compaction arrangement for a second mechanical compaction of the electrode to form a second compacted state of the electrode,
wherein the electrode has a higher compaction in the second compacted state than in the first compacted state, and
wherein the device having the thermal energy source is arranged downstream of the first compaction arrangement and upstream of the second compaction arrangement.

28. The apparatus according to claim 19, wherein at least one of the first compaction arrangement or the second compaction arrangement has a roller arrangement.

29. An electrode that is produced in accordance with the method according to claim 16.

30. A battery cell comprising the electrode according to claim 29.
